(19) United States
(12) Patent Application Publication
(10) Pub. No.: US 2015/0175944 A1
(43) Pub. Date: Jun. 25, 2015

(54) SANITARY APPLICATOR

(71) Applicant: EURVEST SA, Nivelles (BE)

(72) Inventors: Agnieszka Sikorska, Trawniki (PL); Alain Luciani, Auriol (FR); Jean Klimis, Bruxelles (BE); Estelle Bertignon, Mons (BE)

(73) Assignee: EURVEST SA, Nivelles (BE)

(21) Appl. No.: 14/409,198

(22) PCT Filed: Feb. 11, 2014
(86) PCT No.: PCT/EP2014/052674

§ 371 Date: Dec. 18, 2014

(30) Foreign Application Priority Data
Feb. 25, 2013 (EP) 13156652.3

(51) Int. Cl. C11D 17/04; C11D 3/38; C11D 3/37; C11D 3/22; C11D 3/20

(52) U.S. Cl. CPC C11D 17/041; C11D 3/221; C11D 3/2065; C11D 3/3719; C11D 3/3753; C11D 3/38

(57) ABSTRACT

The present invention is directed to a soluble applicator for applying self-adhesive composition onto the wall of sanitary elements, preferably a toilet basin. The invention is directed to a soluble applicator which may comprise at least one materials selected among monosaccharide or disaccharide based components, sugar alcohols, polyamide resin mixtures, soluble polymers or soluble gelling agents or mixtures thereof, to a sanitary product comprising such applicator and to a process for its manufacture.

### FIELD OF THE INVENTION

The present invention relates to sanitary composition for cleaning and/or disinfecting and/or deodorizing sanitary elements, especially toilets. It particularly relates to the application of self-adhesive products onto the sanitary elements, preferably detergent compositions.

### TECHNICAL BACKGROUND

Several solutions exist for cleaning and/or disinfecting and/or deodorizing sanitary elements, especially toilets. A first solution consisted in a block placed in cage.

Self-adhesive detergent compositions which can be applied directly to the wall of a sanitary element are also known in the art. They correspond to solid, semi-solid or gel substances which are applied over the wall of a sanitary element, for example the faience of the toilet. These compositions have cleaning and/or disinfecting and/or deodorizing properties and are continuously washed off their supporting wall with the flushes.

Nevertheless, it is desirable to prevent the contact of the detergent composition with the hands of the user which may cause discomfort and/or chemical contaminations. Different applicator devices have thus been developed to prevent any direct contact while the product is handled, positioned and adhered to the sanitary element.

For example, WO-A-2007/008531 discloses a device which includes a tubular body and a plunger. The flowable detergent material, contained inside the body of the device, is dispensed through an orifice in controlled unitized doses to a surface when the plunger is moved toward the body by the user. However, this type of applicator is complex to manufacture and may be unhygienic since the same device is applied several times to the wall of sanitary elements over extended period of times to apply the doses.

Simplified applicators have since been disclosed to apply self-adhesive detergent composition onto sanitary articles.

In WO-A-2011/135330, the self-adhesive composition is contained in a cavity and applied to the wall of the sanitary element with a piston which is moveably engageable within the cavity. This solution however involves similar constraints since the device has a complex shape while it requires high amounts of material, such as plastic, to manufacture the grip. In addition, the device is intended to be reused for several applications.

EP-A-2141221 discloses a self-adhesive preformed detergent product which is provided inside a containment portion made from flexible or rigid material. Such portion is used to stick a preformed detergent product directly onto the surface of the sanitary apparatus while preventing any direct contact of the user with the detergent composition. Nevertheless, the containment portion still needs to be removed after application to let the water come in contact with the detergent composition. FIGS. 7a-d of the document are representative of the method of application of a self-adhesive detergent product and show that the device is manipulated with both hands of the users, to grip and remove the containment portion.

Other applicators have been disclosed such as in the European patent application EP-A-2281756. The device disclosed therein comprises a deformable and squeezable container which dispenses the self-adhesive detergent product through an outlet mouth in a forming unit upon the wall of a sanitary basin. Although this type of applicator eliminates the need of a support which has to be removed at the end of the product life, the applicator itself still needs to be removed after application with the related ecological problems.

In WO 2008/100393, the detergent and adhesive composition is provided between two solid substrates which both need to be removed before the use of the composition. The first substrate is removed to apply the adhesive composition directly onto the wall of the toilet. Nevertheless, there is still a need to manipulate the product into the toilet basin after application to remove the second substrate before one can actually use the product. This type of product also leads to additional disposable materials.

### SUMMARY OF THE INVENTION

The applicant has surprisingly discovered that the drawbacks of the prior art could be overcome with the articles of the invention. It has been found that the applicators and products according to the instant invention are environmentally friendly, easy to manufacture and safe to any user. The applicators and products according to the invention can be safely manipulated by the user without any risk of chemical contamination and resists a sufficient force to stick the composition onto the sanitary element with a single hand. The user does not have to remove either the applicator after the self-adhesive composition is applied onto the element which considerably simplifies the use of the product. The applicator according to the instant invention also simplifies the formulation of the compositions used into the sanitary installations.

A first aspect of the invention is concerned with a soluble applicator (1) for self-adhesive composition, preferably a detergent composition.

According to one embodiment of the invention, the soluble applicator comprises at least one materials selected among glucose based components, polyamide resin mixtures, soluble polymers or soluble gelling agents or mixtures thereof.

According to one embodiment of the invention the soluble applicator is made of one or mixtures of materials selected among glucose, sucrose, polyacrylamide, polyacrylic polymer, polyvinylpyrrolidone (PVP), polyvinyl alcohol (PVA), partially hydrolyzed polyvinyl acetate, polyisocyanates, polydiallyldimethylammonium chloride (polyDADMAC), polyethylene glycol (PEG), agar gel, alginate, gums or gelatin.

According to one embodiment of the invention the soluble applicator consists essentially of the same material selected among polyvinyl alcohol, a polyamide, glucose or sucrose.

According to one embodiment of the invention the soluble applicator further comprises a grip portion (21).

According to one embodiment of the invention the soluble applicator comprises a scoreline (22) to allow the breakage of the grip portion (21) off the applicator (1).

According to one embodiment of the invention the soluble applicator comprises at least two curved arms (3) that are radially oriented.

According to one embodiment of the invention, the soluble applicator exhibits a Texture Profile Hardness above 7, preferably above 9 and more preferably above 11.

According to one embodiment of the invention the soluble applicator exhibits a complete dissolution in a toilet basin of less than 70 flushes, preferably less than 60 flushes and more preferably less than 50 flushes.

35

According to one embodiment of the invention, the soluble applicator further comprises an additive such as disinfectants, insecticides, enzymes, colored particles, preservatives, biocides, anti-lime scale, dyes, colorant and/or antibacterial agents therein in an amount of from 0 to 20 wt % of the total weight of the applicator, preferably from 1 to 5 wt %.

According to one embodiment of the invention, the soluble applicator according to anyone of claims 1 to 10, which further comprises perfume, in an amount of from 1 to 25 wt % of the total weight applicator, preferably from 1 to 20 wt %.

Another aspect of the invention is directed to a self-adhesive product comprising a self-adhesive unit composition, preferably a self-adhesive detergent unit composition, being attached to a soluble applicator (1) as defined according to the invention.

According to one embodiment of the invention, at least part of the applicator of the self-adhesive is embedded into the self-adhesive unit composition.

According to one embodiment of the invention, the self-adhesive further comprises on one of its side a peelable film onto the self-adhesive composition.

Another aspect of the invention is directed to a process for the manufacture of a soluble applicator comprising (a) the mixing of the-mixing the ingredients into a solvent or mixture of solvents, (b) removing at least part of the solvent to harden the form thus obtained and (c) shaping the paste thus obtained into the desired shape.

Another aspect of the invention is directed to the use of the soluble applicator with a cleaning, disinfection and/or deodorization composition into a sanitary element, preferably a toilet basin.

Another aspect of the invention is directed to the use of one or several materials selected among sugars, polyamide resin mixtures, polyvinyl alcohol, agar gel or gelatin gel for the manufacture of an applicator for self-adhesive compositions, preferably for sanitary self-adhesive detergent compositions.

Another aspect of the invention is directed to the use of a soluble applicator into a sanitary element, preferably a toilet basin.

Another aspect of the invention is directed to the use of the self-adhesive product for cleaning, disinfecting and/or deodorizing a sanitary element, preferably a toilet basin.

### FIGURES

FIGS. 1 to 6 illustrate different shapes of applicators according to the instant invention.

### DESCRIPTION OF EMBODIMENTS OF THE INVENTION

The present invention is disclosed in more details in the description that follows.

Typically, the applicators according to the instant invention are made of materials which are solid (in opposition to the liquid state) at room temperature but soluble in water, i.e. in cold water. Typically, the materials exhibit a solubility of at least about 100 g/L in water at 20° C.

One in the field will thus understand that the materials which are useful for the applicators according to the invention are any of the soluble materials of the following categories or mixtures thereof:
a) Monosaccharide or disaccharide based components such as glucose, sucrose or fructose, including syrups exhibiting a high viscosity such as sucrose, or any mixtures thereof.
b) Sugar alcohols, such as isomalt and maltitol.
c) Soluble resins, e.g. polyamide resins or polyacrylamide. Examples of marketed available polyamide resins are Sylvagel® grades marketed by Arizona Chemical.
d) Soluble plastics, e.g. a polyacrylic polymer, polyvinyl pyrrolidone (PVP) polyvinyl alcohol (PVA), partially hydrolyzed polyvinyl acetate, polyisocyanates, polydiallyldimethylammonium chloride (polyDADMAC) or polyethylene glycol (PEG). Suitable examples of soluble plastics are marketed by Monosol®.
e) Soluble gelling agents, such as agar, gums, alginates or gelatin.

Preferred agents are sucrose, isomalt, PVA or mixture thereof. The use of this type of material keeps the costs of manufacture at the lowest.

Within the present invention, the term “monosaccharide based component” is to be interpreted as component which comprises monosaccharide elements which basic chemical formula is CₓH₂ₓOₓ wherein x is an integer usually of at least 3 and typically between 3 and 8. Examples of appropriate monosaccharide based materials are glucose (dextrose), fructose (levulose) or galactose. Disaccharides are made of two monosaccharide elements.

Within the present invention, the term “sugar alcohol” is to be interpreted as a hydrogenated form of a saccharide based component whose carbonyl group has been replaced with a hydroxyl group. They have the general formula H(HCHO)ₙ₊₁H and may also be referred to as polyols. Examples of appropriate sugar alcohols are sorbitol, mannitol, maltitol or isomalt.

According to one embodiment of the instant invention, it is now possible to provide an applicator consisting essentially of one type of material. In the present context, the term “consisting essentially” is meant to exclude any component or mixtures of component. Typically, this term defines that at least 98% w/w of the composition of the applicator is made of the same material, preferably at least 99% w/w and more preferably at least 99.5% w/w.

Albeit the applicators according to the invention can be made of a single forming material, they may also include additives, i.e. processing or o formulation additives. Within the meaning of the present application, additives mean for example disinfectants, insecticides, enzymes, particles such as colored PET or PP, preservatives, biocides, anti-lime scale but also dyes or colorant and/or antibacterial agents. The total amount of additives is generally within the range of 0% to 20%, preferably from about 1% to 20%, more preferably from about 1% to 5% of the total weight of the applicator.

The applicators according to the instant invention can further comprise perfume. Appropriate perfumes are for example disclosed at paragraph of U.S. 2008/0255017 which is incorporated herein by reference. The fragrance can be based on flowers fragrance, fruits, spices, and the like. The perfume can be of natural origin or can be synthetized. It is present generally in an amount from 0.1% to 25%, preferably from 1% to 20% by weight of the total applicator. The addition of perfume directly into the applicator is particularly useful since perfume may alter the behavior and properties of self-adhesive compositions when incorporated therein, i.e. in detergent compositions. Adding the perfume into another element of the sanitary product thus simplifies the formulation of the self-adhesive composition.

The applicator is progressively dissolved and disappears with the water running onto it. For its use in toilet basins, the applicator advantageously disappears in less than 70 flushes, preferably less than 60 flushes, more preferably less than 50 flushes. This number of flushes is rapidly attained in domestic use and particularly in large families, which provides a rapid and convenient disappearance of the applicator.

The applicator according to the instant invention can disappear much faster than the detergent dose. Since transparence or aesthetic detergent compositions are usually developed and contemplated in this field, the applicator does not alter the visual aspect of these compositions.

The applicators of the invention can have various shapes, such as rosette shapes or different visual aspects. The affordable materials which come into the composition of the applicators make it possible to easily adapt the visual aspect of the product and offer different shapes to the user.

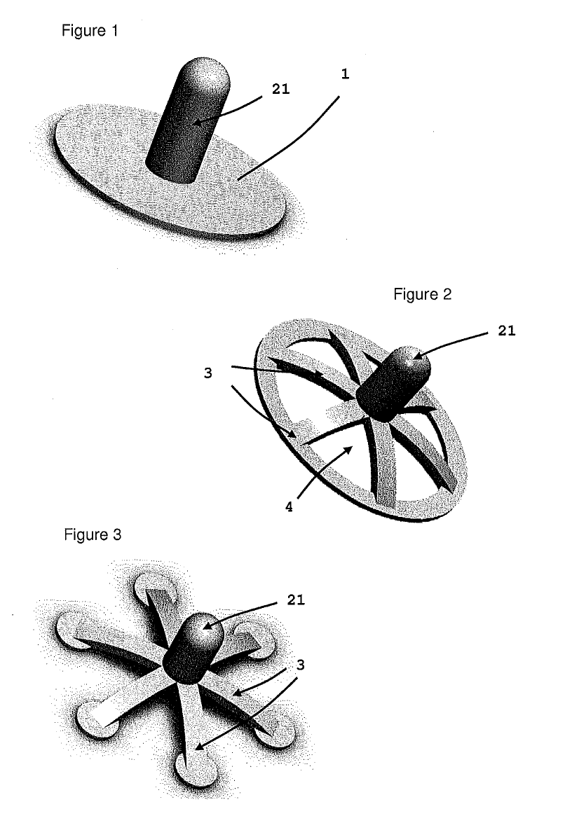

An example of shape of an applicator according to the instant invention is illustrated in FIGS. 1 to 4. FIGS. 1, 2, 4 and 5 illustrate a typical circular applicator. FIG. 3 illustrates a typical rosette shaped applicator having arms which are oriented radially. FIG. 6 illustrate an example of a different shape of the plateform. Other different shapes can be envisaged by the skilled man.

The size and thickness of the applicator is such that it bears the significant mechanical stress resulting from the pressure applied by the user when fixing the self-adhesive product onto the wall of the sanitary element. Typically, this stress corresponds to about 25N. Typically, the thickness of the applicator is comprised within the range of about 0.6 to 16 mm, preferably about 2 to 10 mm.

In the event the composition of the applicator is based on at least one sucrose component, the product exhibits a hardness that can be measured using scales that are conventionally used in the food industry, albeit this field remains far from the instant field of the invention (e.g. Sensory Evaluation of Food, Principles and Practices, Harry T Lawless & Hildegarde Heymann (1998). Typically, the applicator according to the instant invention would exhibit a texture profile hardness above 7, preferably above 9 and most preferably above 11.

The applicator can be provided separately from the detergent doses, or advantageously in combination into a ready to use product. This second alternative offers the user the possibility to pick and apply directly the detergent composition onto the sanitary surface without touching the composition and the sanitary element. The applicators according to the invention are intuitive and easy to manipulate and use. They can be applied with one hand only.

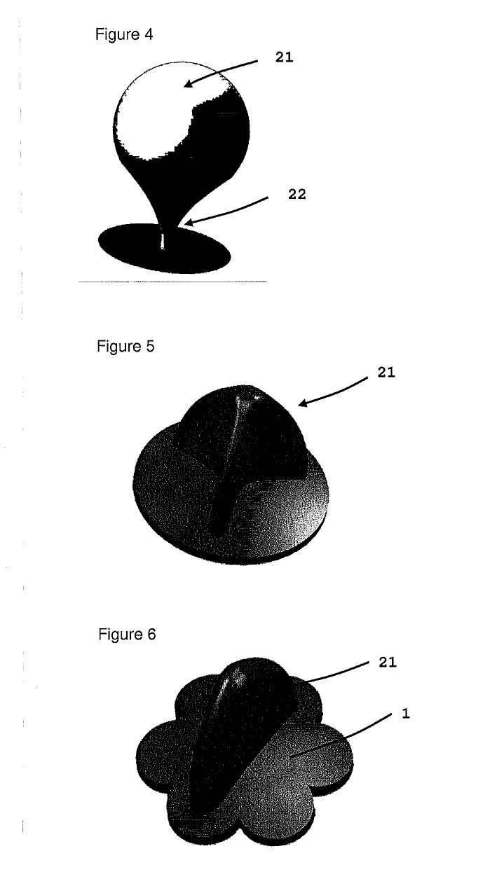

According to a preferred embodiment, the applicator is shaped in such way that it forms a protruding portion or grip which can be seized and handled by the fingers of the user. An example of such grip portion is represented by the number 21 in the FIGS. 1 to 4. The grip itself may have different forms as represented in FIGS. 1 and 4. Typically, the grip portion has a size which allows its manipulation. The examples of FIGS. 5 and 6 represent different shapes of the grip portion. An appropriate length may fall for example between 5 and 25 mm, preferably between 10 and 20 mm.

According to another embodiment, it may be useful to allow the grip of the applicator to be detached from the rest of the product once it is placed and fixed onto the wall of the sanitary element to provide an improved esthetic look. Particularly, the user can break the grip off the applicator, i.e. with a twist after he has fixed the product onto the wall of the sanitary element. This can be envisaged by providing a scoreline onto a portion of the grip of the applicator or design a portion which exhibits a weaker resistance in comparison to the rest of the applicator. For example, the applicator represented in FIG. 4 comprises a grip with a different width along the length of the portion to facilitate the separation of the grip at the site where it is attached to the rest of the applicator. Different designs can also be envisaged by the skilled person.

The form of the applicator is such that it does not completely cover the inner and outer surface of the self-adhesive composition, to let, on the one hand one portion of the composition stick to surface of the sanitary wall and on the other hand, let the composition come in contact with the water once the product is applied onto the wall.

Typically, the applicator may form a cavity which is opened on the two ends in which the self-adhesive composition is placed or a platform on which a self-adhesive composition is placed. According to another preferred embodiment, the applicator comprises curved arms oriented radially from a central point in a similar shape of a semi-sphere. The curved arms thus form a cavity that can contain the self-adhesive composition.

The figures illustrate examples of applicators according to the instant invention. In FIG. 1, the applicator has the shape of a plateform on which the self-adhesive composition is placed (on the opposite side of the side comprising the grip (21)). A surface of the composition is thus left available to adhere to the wall of a sanitary element while at the same time the thickness of the composition remains accessible to the running water after the product is applied. FIGS. 2 and 3 illustrate an applicator according to the invention comprising six bended arms (3) and a grip (21). The arms can be connected one with each other or simply spread radically from the center of the applicator. The composition is placed on the opposite side of the surface having the grip. After application to the wall of a sanitary element, the portions (4) between the arms allow the water to come in contact with the composition. The applicator of FIG. 4 has the shape of a plateform on which the self-adhesive composition is placed (on the opposite side of the plateform comprising the grip) and works similarly as in FIG. 1.

The applicators according to the invention can be prepared according to the following steps:
mixing the ingredient in an appropriate solvent or mixture of solvents,
removing at least part of the solvent in order to harden the thus obtained form, for example by heating.
shaping the paste thus obtained into the desired shape, for example by molding and optionally by pressing.

The solvent is removed until the shaped paste becomes hard enough to be used.

The man skilled in the art would conventionally identify the minimal hardness for the contemplated invention.

Once prepared, the applicator can be attached to a self-adhesive composition. Most preferably the self-adhesive composition is a detergent composition, in the form of a single dose. Examples of detergent that are appropriate for the instant invention are known in the art.

Typically, they are disclosed in the documents U.S. Pat. No. 6,667,286 or WO2008/100393 which content is incorporated herein by reference.

These detergent compositions usually comprise at least one or several of the following adhesion promoters: polyethylene glycol, cellulose, polysaccharides, starches, whereby the cellulose is selected from the group consisting of sodium carboxymethyl cellulose, hydroxyethyl cellulose, and hydroxypropyl cellulose and the polysaccharides is selected from the group consisting of xanthum gum, agar, gelatin gum, acacia gum, carob bean flour, guar gum, and combination thereof; alginates, diurethanes, gelatins, peetines, oleyl amines, alkyl dimethyl amine oxides, alkyl ethyl sulfates, alkyl etoxylate, stearates, alkali metal stearates and combinations thereof.

Without being limited to these examples, the combination can be performed either by inserting the composition into a cavity made from the shape of the applicator, embedding at least one portion of the applicator into the detergent composition itself to improved cohesion between the two elements or fixing the applicator directly onto the surface of the detergent dosage. The detergent composition may be softened or melted to improve the processing of the combination of the two elements into the desired final product.

According to one embodiment, the final products are provided with a film onto the adhesive part for packaging and storage purposes. Typically, each product may be placed on a film individually or placed with other products onto the same film. For example, the film can be made of silicone.

Before application, the user will seize the product with the fingers of one hand, i.e. with the grip portion available on one side of the product, peel the film off the adhesive surface of the product on the opposite side of the product with the other hand and apply directly the product onto the wall of the sanitary element with an appropriate pressure. Once the product is applied, the user only has to release the grip or break it with a twist before using it.

In the invention, all percentages are by weight, based on the total weight of the applicator, unless specified otherwise.

The following examples illustrate the invention without limiting it.

### EXAMPLES

The following compositions were manufactured and tested into a toilet basin. Each of them dissolves easily throughout the lifetime of the product with the water of the flushes.

A. Sugar based formulations

| Component | Wt % | | | | | | | |
|---|---|---|---|---|---|---|---|---|
| Glucose/ | 22.00 | 22.00 | 25.00 | 25.00 | 43 | 50.00 | 100 | |
| glucose- | | | | | | | | |
| fructose | | | | | | | | |
| syrup | | | | | | | | |
| Sugar | 58.00 | 48.00 | 60.00 | 65.00 | 43 | 50.00 | | 100 |
| Water | 20.00 | 30.00 | 15.00 | 10.00 | 14 | | | |

B. Sugar alcohol based formulations

| Component | Wt % | | | | |
|---|---|---|---|---|---|
| Sugar | 75.00 | 80.00 | 70.00 | 85.00 | 65.00 |
| alcohol - | | | | | |
| Isomalt | | | | | |
| Water | 25.00 | 20.00 | 30.00 | 15.00 | 35 |

C. Polyamide resin based formulations

| Component | Wt % | | | |
|---|---|---|---|---|
| Sylvagel HP5 | 50.00 | 40.00 | 30.00 | — |
| Sylvagel HP4 | — | — | — | 80.00 |
| Propylene glycol | 50.00 | 60.00 | 70.00 | — |
| Perfume | — | — | — | 20.00 |

*Optionally different solvents or mixtures of solvent can be used such as: propylene glycol/water, dipropylone glycol, dipropylone glycol/water, glycerin, castor oil, PEG 200 oleate.

D. Polyvinyl based formulation

| Component | Wt % |
|---|---|
| Polyvinyl alcohol | 100.00 |

E. Gel based formulation

| Component | Wt % | |
|---|---|---|
| Agar | 0.50 | — |
| Gelatin | — | 20.00 |
| Water | 44.00 | 80.00 |
| Sugar | 54.50 | — |
| Citric acid | 1.00 | — |

The above applicator composition may be used with different detergent compositions, which are rigid but plastic enough to be easily applied onto the sanitary wall, for example of a toilet basin. Examples of detergent compositions are provided below.

| Component [%] | 1 | 2 | 3 | 4 |
|---|---|---|---|---|
| Glucose syrup | 15.0-52.0 | 15.0-52.0 | 15.0-52.0 | 15.0-52.0 |
| Sugar | 9.0-45.0 | 9.0-45.0 | 9.0-45.0 | 9.0-45.0 |
| Water | 3.0-10.0 | 3.0-10.0 | 2.0-10.0 | |
| Anionic surfactants | 12.0-35.0 | 12.0-35.0 | 12.0-35.0 | 12.0-35.0 |
| Glicerine | 0.5-5.0 | | | 0.5-5.0 |
| Glicol propylene | | | | 0-5.0 |
| Castrol oil/Solid | | | | |
| paraffin/liquid | | | 0-2.0 | |
| paraffinium | | | | |
| Emulsifier | | 1.0-3.0 | | |
| Fragrance | 5.0 | 5.0 | 3.0-5.0 | 3.0 |

| | |
|---|---|
| Dye | 0.0020-0.0050 |

1. A soluble applicator (1) for self-adhesive composition, preferably a detergent composition.

2. The soluble applicator according to claim 1, comprising at least one materials selected among monosaccharide or disaccharide based components, sugar alcohols, polyamide resin mixtures, soluble polymers or soluble gelling agents or mixtures thereof.

3. The soluble applicator according to claim 1, made of one or mixtures of materials selected among glucose, sucrose, fructose, maltitol, isomalt, polyacrylamide, polyacrylic polymer, polyvinyl pyrrolidone (PVP), polyvinyl alcohol (PVA), partially hydrolyzed polyvinyl acetate, polyisocyanates, polydiallyldimethylammonium chloride (polyDADMAC), polyethylene glycol (PEG), agar gel, alginate, gums or gelatin.

4. The soluble applicator according to claim 1, consisting essentially of the same material selected among polyvinyl alcohol, a polyamide, glucose or sucrose.

5. The soluble applicator according to claim 1, which further comprises a grip portion (21).

6. The soluble applicator according to claim 5 which comprises a scoreline (22) to allow the breakage of the grip portion (21) off the applicator (1).

7. The soluble applicator according to claim 1, which comprises at least two curved arms (3) that are radially oriented.

8. The soluble applicator according to claim 1, which exhibits a Texture Profile Hardness above 7.

9. The soluble applicator according to claim 1, which exhibits a complete dissolution in a toilet basin of less than 70 flushes.

10. The soluble applicator according to claim 1, which further comprises an additive such as disinfectants, insecticides, enzymes, colored particles, preservatives, biocides, anti-lime scale, dyes, colorant and/or antibacterial agents therein in an amount of from 0 to 20 wt % of the total weight of the applicator.

11. The soluble applicator according to claim 1, which further comprises perfume, in an amount of from 1 to 25wt % of the total weight applicator.

12. A self-adhesive product comprising a self-adhesive unit composition, preferably a self-adhesive detergent unit composition, being attached to a soluble applicator (1) as defined according to claim 1.

13. The self-adhesive product according to claim 12 wherein at least part of the applicator is embedded into the self-adhesive unit composition.

14. The self-adhesive product according to claim 12, which further comprises on one of its side a peelable film onto the self-adhesive composition.

15. A process for the manufacture of a soluble applicator according to claim 1, comprising (a) the mixing of the- mixing the ingredients into a solvent or mixture of solvents, (b) removing at least part of the solvent to harden the form thus obtained and (c) shaping the paste thus obtained into the desired shape .

16. Use of one or several materials selected among monosaccharide or disaccharide based components, sugar alcohols, polyamide resin mixtures, polyvinyl alcohol, agar gel or gelatin gel for the manufacture of an applicator for self- adhesive compositions, preferably for sanitary self-adhesive detergent compositions.

17. Use of a soluble applicator according to claim 1 into a sanitary element, preferably a toilet basin.

18. Use of the self-adhesive product according to claim 12 for cleaning, disinfecting and/or deodorizing a sanitary element, preferably a toilet basin.
